(19) United States
(12) Patent Application Publication
(10) Pub. No.: US 2014/0199546 A1
(43) Pub. Date: Jul. 17, 2014

(54) MULTI-BRANCHED N-DOPED CARBON NANOTUBES AND THE PROCESS FOR MAKING SAME

(71) Applicant: HER MAJESTY THE QUEEN IN RIGHT OF CANADA, AS REPRESENTED BY THE MINISTER OF NATIONAL DEFENCE, OTTAWA (CA)

(72) Inventors: Xueliang SUN, London (CA); Minhea Ioan IONESCU, London (CA); Hakima ABOU-RACHID, Quebec (CA)

(73) Assignee: HER MAJESTY THE QUEEN IN RIGHT OF CANADA, AS REPRESENTED BY THE MINISTER OF NATIONAL DEFENCE, OTTAWA (CA)

(21) Appl. No.: 13/739,580

(22) Filed: Jan. 11, 2013

(51) Int. Cl. C01B 31/02

(52) U.S. Cl. CPC C01B 31/0226; C01B 31/022
USPC 428/367; 427/249.1

(57) ABSTRACT

A multibranched N-doped carbon nanotube (CNT) and the process of production are described. The CNT includes a first-stage stalk having a direction comprising a first-stage base, and a first-stage top opposite to and attached with the first-stage base, at least two second-stage bundles, each of which comprises a second-stage base attached to the first-stage top, and second-stage top opposite to and attached with the second-stage base, and wherein the second-stage bundles branch from the first-stage stalk in substantially the direction of the first stage stalk, and a plurality of third-stage nanotubes each of which comprises a third-stage base attached to the second-stage top, a third-stage top opposite to and attached with the third-stage base, and wherein the plurality of third-stage nanotubes branch from the second-stage bundles.

### FIELD OF THE INVENTION

The present relates to vertically aligned multi-branched N-doped (nitrogen-doped) carbon nanotubes (CNT) and a process for making them.

### BACKGROUND

CNTs have drawn considerable attention from researchers due to their outstanding electrical and mechanical properties. Their complex spatial architecture has contributed to numerous applications of nanotubes in sensors, fuel cells, batteries, field emission devices, transistors, and logic circuits. Continuous requirements of miniaturization and complex nanoscale devices have generated an increasing interest in developing novel nanomaterials with complicated structures. In order to integrate nanomaterials with different properties into functional systems, attention is becoming focused on branched CNTs.

Up to now, several techniques have been employed to produce branched carbon nanotubes. Initially, Y-shaped or branched CNTs have been synthesized by arc discharge and alumina template. Furthermore, a high-intensity electron beam has been used to join crossed CNTs. Another approach used a two-step process to attach catalyst particles to the grown CNTs during the chemical vapor deposition (CVD) growth process to initialize and sustain branches formation. Recently, more complicated branched CNTs have been reported by using a pyrolysis method, in which gas flow fluctuation has been considered the key factor that influences the branch occurrence. Inter-connected CNT networks have been prepared by Fu Y. et al. (“Templated Growth of Covalently Bonded Three-Dimensional Carbon Nanotube Networks Originated from Graphene” Advanced Materials Volume 24, Issue 12, pages 1576-1581, Mar. 22, 2012) by CVD on nickel template.

However, previously reported deposition methods have disadvantages of inconsistent repeatability and introduction of external templates or additional steps that make the process complex and difficult to control. A single-step method to synthesize branched CNTs with a strong control of structure and composition is still desirable.

### SUMMARY

It is therefore an aim of the present invention to provide a multi-stage multi-branched N-doped carbon nanotube and a process for producing it in a single-step controlled operation.

In accordance with one aspect of the present invention, there is provided a multibranched N-doped carbon nanotube comprising: a first-stage stalk having a direction and comprising a first-stage base, and a first-stage top opposite to and attached with the first-stage base, wherein the first-stage base includes a catalyst inclusion, at least two second-stage bundles, each of which comprises a second-stage base attached with the first-stage top, and a second-stage top opposite to and attached to the second-stage base, and wherein the second-stage bundles branch from the first-stage stalk in substantially the direction of the first stage stalk, and a plurality of third-stage nanotubes each of which comprises a third-stage base attached with the second-stage top, a third-stage top opposite to and attached to the third-stage base, and wherein the third-stage nanotubes branch from the second-stage bundles.

In accordance with another aspect of the N-doped carbon nanotube herein described the third-stage nanotubes branch from the second-stage bundles in substantially the same direction as the first stage-stalk.

In accordance with another aspect of the N-doped carbon nanotube herein described, the first-stage stalk has an average diameter of about 145 nm to about 450 nm.

In accordance with yet another aspect of the N-doped carbon nanotube herein described, the first-stage stalk has an average diameter of about 200 nm to about 250 nm.

In accordance with still another aspect of the N-doped carbon nanotube herein described, the first-stage stalk has an average diameter of about 210 nm.

In accordance with yet still another aspect of the N-doped carbon nanotube herein described, the second-stage bundles has an average diameter of about 25 nm to about 60 nm.

In accordance with a further aspect of the N-doped carbon nanotube herein described, the second-stage bundle has an average diameter of about 40 nm.

In accordance with yet a further aspect of the N-doped carbon nanotube herein described, the plurality of third-stage nanotubes each has an average diameter of about 5 nm to about 25 nm.

In accordance with still a further aspect of the N-doped carbon nanotube herein described, the plurality of third-stage nanotubes each has an average diameter of about 10 nm to about 20 nm.

In accordance with yet still a further aspect of the N-doped carbon nanotube herein described, the plurality of third-stage nanotubes is from 10 to 30, branching from the second-stage bundles.

In accordance with one embodiment of the N-doped carbon nanotube herein described, the plurality of third-stage nanotubes is from 20 to 25, branching from the second-stage bundles.

In accordance with another embodiment of the N-doped carbon nanotube herein described, comprising a total length from the first-stage base to the third-stage top of about 4 μm to about 6 μm.

In accordance with another aspect of the present invention, there is provided a process of producing vertically aligned multiple-branched nitrogen-doped carbon nanotubes, comprising the steps of: providing a temperature controlled deposition chamber adjusted to a temperature from 675° C. and 850° C.; providing a liquid having a carbon/nitrogen feedstock and an iron catalyst at a branching concentration, providing a carrier gas; providing a substrate in the chamber onto which the nanotubes are deposited; injecting a volume of the liquid into the gas to produce a fine mist in the chamber oriented towards the substrate for a period of time between 40 and 1 hour, wherein the liquid injected pyrolyzes the iron catalyst and the carbon/nitrogen feedstock into active species that adhere to the substrate and form the vertically aligned multiple-branched nitrogen-doped carbon nanotubes.

In accordance with yet another embodiment of the process herein described, the carbon/nitrogen feedstock is acetonitrile.

In accordance with still another embodiment of the process herein described, the iron catalyst is ferrocene.

In accordance with yet still another embodiment of the process herein described, the branching concentration of the ferrocene is greater than 0.5 wt % in the liquid.

In accordance with a further embodiment of the process herein described, the branching concentration of the ferrocene is from 2.5 wt % to 3.5 wt % of the liquid.

In accordance with a further embodiment of the process herein described, injecting the volume of the liquid into the gas is at a rate of about 0.02 ml/min to about 0.06 ml/min.

In accordance with yet a further embodiment of the process herein described, the substrate comprises a high purity silicon wafer comprising a native oxide layer.

In accordance with still a further embodiment of the process herein described, the substrate includes an Al underlayer of an average thickness of about 30 nm.

In accordance with yet still a further embodiment of the process herein described, the period of time is about 50 minutes.

Further in accordance with another embodiment of the process herein described, the temperature of the deposition chamber is from about 700° C. to about 800° C.

### BRIEF DESCRIPTION OF THE DRAWINGS

Reference will now be made to the accompanying drawings, showing by way of illustration a particular embodiment of the present invention and in which:

FIG. 1 is a schematic process flowsheet of a spray pyrolysis chemical vapour deposition system for producing N-doped carbon nanotubes according to one embodiment of the present invention;

FIG. 2a is Scanning Electron Micrograph (SEM) image of a well-aligned branched CNTs array according to one embodiment of the present invention clearly indicating with different generations/stages visible;

FIG. 2b is a further detailed smaller scale SEM image of a well-aligned branched CNTs of FIG. 2a indicating the positions of the end of the 1^{st} generation/stage, the start of the second generation/stage; the end of the second generation/stage and the beginning of the third generation/stage of CNTs indicated;

FIG. 3a Transmission Electron Micrograph (TEM) image a branched CNTs according to one embodiment of the present invention illustrating from left to right; Y-junctions on third-generation/stage of nanotubes; multiple branches formed between the third and second-generation/stage bundles of CNTs; multiple branches formed between second-generation/stage bundles of CNTs and a first generation/stage stalk nanotube; and the stalk nanotube with catalyst inclusion at the bottom right hand corner of the FIG. 3a;

FIG. 3b is a further detailed smaller scale TEM image of a branched CNT according to another embodiment of the present invention a top of a CNT and Y-junctions of the third generation/stage of nanotubes, and a clear illustration of the multiple stalks of CNT;

FIG. 4a is a Raman spectrograph of a multibranched CNTs according to one embodiment of the present invention;

FIG. 4b is an X-ray photoelectron spectroscopic (XPS) survey scan of a multibranched CNTs according to one embodiment of the present invention;

FIG. 4c is an (nitrogen) N 1s XPS spectrum of a multibranched CNTs according to one embodiment of the present invention;

FIG. 5a is a SEM of a multibranched CNTs according to one embodiment of the present invention produced using 2.5 wt % ferrocene catalyst in solution;

FIG. 5b is a SEM of a multibranched CNTs according to another embodiment of the present invention produced using 0.5 wt % ferrocene catalyst in solution; and

FIG. 6 is a schematic diagram (not to scale) of a growth mechanism of the a branched CNT according to one embodiment of the present invention.

### DETAILED DESCRIPTION OF PARTICULAR EMBODIMENTS

The multi-branched N-doped (nitrogen-doped) carbon nanotubes (CNT) and a process for making them will be further described with references to the appended figures and description.

The expression “N-doped carbon nanotube” is defined herein as a carbon nanotube comprising a quantity of nitrogen within the structure of the nanotube.

The term “multibranched” nanotube is defined herein as a nanotube that include a plurality of branched nanotubes, and that those braches are found at one end of the nanotube.

The term “hierarchical” nanotube is defined herein as a nanotube that includes different generations or stages of development that are oriented in a direction that is substantially co-linear with the radial axis of the nanotube or perpendicular to the substrate. This hierarchical structure is due to the means by which the nanotube is produced through a series of mechanistic steps. The multibranched N-doped carbon nanotubes described herein have at least twp and more preferably three generations/stages.

The expression “vertically aligned” means that the nanotubes described herein are produced to be vertically aligned with adjacent CNTs and are analogous to trees in a forest.

The “substrate” is defined herein as a material on which the N-doped nanotubes described herein are produced.

The expression “first-stage stalk” is defined herein as the portion of the nanotube that is first produced, or the “first generation. This first-stage stalk is on and adjacent with a substrate and catalyst. The terms “stage” and “generation” are used interchangeable in this description. The stalk is oriented in a direction in an axial orientation along its length or is perpendicular to the substrate. The “first-stage base” is a lowest or base portion of the first-stage stalk that has a catalyst “inclusion” that is associated with the substrate. The first-stage base extends towards a “first-stage top” opposite the first-stage base. The term “inclusion” is defined herein to be exactly that, a portion of the first-stage base stalk nanotube that includes a higher concentration of catalyst. The inclusion is visible in the Scanning Electromicrographs included herein.

The expression “second-stage bundle” is defined herein as a second generation of nanotubes and is attached to the first-stage top. At least two second-stage bundles branching from the first-stage top. There may be from 2 to 25 second-stage bundles per first-stage stalk, and preferably from 6 to 20 second-stage bundles per first-stage stalk. The branched bundles are oriented in substantially the direction of the stalk. The term “bundle” is also meant to indicate that this second-stage includes nanotubes that are organized and coalesce into a larger axially oriented nanotube stage or unit in a bundle that is axially combined, and similar to a cylindrically oriented hay bail. The second-stage bundle includes a “second-stage base” that is attached to the first-stage top and is generally associated with coalesced catalyst particles found at this juncture between the first and second stages. The term “second-stage top” is defined as the portion of the second-stage bundle extending from and opposite the second-stage base.

The term “third-stage nanotubes” are defined herein as nanotubes that are produced and found at the second-stage top of the nanotube described herein. The third-stage nanotubes are generally similar to convention N-doped nanotubes with the exception that they are anchored on a second-stage bundle top and generally extend in a direction aligned with or substantially that of the first-stage stalk. There may be from 2 to 25 third-stage nanotube per second-stage bundle, and preferably from 6 to 20 third-stage nanotube per second-stage bundle. The third-stage includes “third-stage base” and a “third-stage top” opposite and extending from the third-stage base.

The first-stage stalk, the second-stage bundle and the third-stage nanotubes all have an different diameter. The stalk diameter in greater than the bundle diameter which is greater than the third-stage nanotube diameter. The average diameter of: the first-stage stalk nanotube is 145 nm to 450 nm; the second-stage bundle is 16 nm to 65 nm; and the third-stage nanotubes is 2 nm to 15 nm. Branches are oriented in substantially the same direction as the stalk nanotube. The diameter of the second-stage bundle or aggregation of branches is almost identical to the diameter of the stalk nanotube.

The first-stage stalk, the second-stage bundle and the third-stage nanotubes all have different lengths. The stalk length is greater than that of the bundle length which is greater than the third-stage nanotube length.

The term “branching concentration” is defined herein as an optimal concentration of catalyst in wt % in a liquid solution that is injected into the process producing the multibranched N-doped CNTs as described herein. The branching concentration induces branch formation of the CNTs, where a concentration below the branching concentration produces a nanotube free of branches. While a concentration above the branching concentration produces the same number of branches and therefore no advantage for the cost of addition catalyst in the liquid solution.

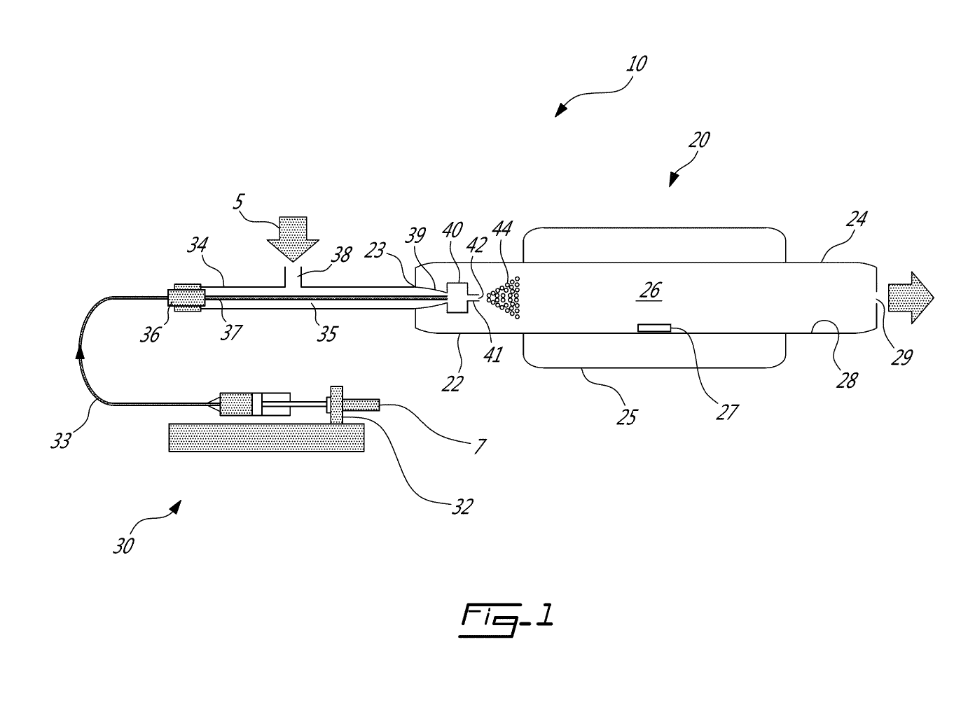

Referring now to the drawings, FIG. 1 illustrates a process flowsheet of a spray pyrolysis chemical vapor deposition (SP-CVD) system 10 for producing N-doped carbon nanotubes (N-CNT) according to one embodiment of the present invention. The system is designed for N-CNT deposition and includes two sections: a first is a substrate temperature control section 20, and the second section is a liquid spray section 30.

The temperature control section 20 controls the temperature within the SP-CVD system 10 from room temperature (20° C.) to 1100° C.; preferably between 650° C. to 850° C. and more preferably from 700° C. to 850° C.

The temperature control section 20 includes: a tube or vessel 22; a heater 25 and substrate base 27.

The tube or vessel 22, is in a preferred embodiment a quartz tube. The tube or vessel 22 defines at least an inlet 23 and an outlet 29, opposite the inlet 22. The inlet 22 is coupled hermetically with the liquid spray section 30. The heater 25 is generally located on an outside wall 24 of the vessel 22 between the inlet 23 and the outlet 29. The temperature of the tube or vessel 22 is raised using the heater 25 that may be any type of indirect or direct heater capable of raising the temperature in the vessel 22 to at least 1100° C. In a preferred embodiment the heater 25 is an inductive electric heater or a steam jacket. The heater 25 in a particularly preferred embodiment of the SP-CVD system 10 is an electronically controlled electric inductive heater.

The substrate base 27 is located within the tube 22 between the inlet 23 and the outlet 29 and in a heated zone 26 within the tube 22 adjacent the heater 25. In a preferred embodiment the substrate base 27 is adjacent lower surface of an inner tube wall 28 although the base 26 may be placed on any inner surface 28 of the tube including an upper surface of the inner tube wall 28.

The substrate on which growth of the N-doped CNT occurs is in a preferred embodiment is a smooth and flat surface, so as to reduce flow fluctuations around the substrate. In a preferred embodiment a silicon wafer of high purity including an native oxide layer (SiO₂), that has not been removed is used as the substrate. In a particularly preferred embodiment the silicon wafer is a oriented n-type (1,0,0) silicon (Si) wafer. The substrate may also include an aluminum (Al) under-layer, with a thickness in the order of 30 nm. In a particularly preferred embodiment a further Al layer is magnetron sputtered on the substrate surface to improve catalyst particle cluster formation. A possible substitute for Al on the substrate surface in the growth of N-doped CNTs is aluminium oxide.

The liquid spray section 30 of the SP-CVD system 10 includes an injection pump 32 that meters a controlled flow of a liquid 7 from a container (not illustrated) at a flowrate in a range of 1 ml/min to 1 μl/min. The liquid injected is generally a solution that includes catalyst dissolved in the solution or dispersed in suspension. At the pressure side of the pump 32 the liquid enters a liquid tube 33 upstream of a carrier gas liquid mixer 34. The mixer 34 includes a carrier gas inlet 38 through which a carrier gas 5 enters an annular mixer section 35. The liquid tube 33 connects to a liquid mixer tube 37 via an adapter 36 at the upstream side of the mixer 34. The mixer tube 37 extends through the annular mixer section 35 towards a venturi 39 that is adjacent an outlet 42 of the mixer 34, to mixture chamber 40 between the venturi 39 and the outlet 42 ensures that the solvent 7 and the carrier gas 5 are well mixed at the low flow rates at a micronozzle 41 and the outlet 42. The outlet 42 was tested with diameters or 261 and 515 μm.

The pressure and flow of the carrier gas 5 at the venture 39 and inside the mixture chamber 40 pulverizes the solvent 7 through the micronozzle 42 into a liquid jet 44, that in a preferred embodiment takes the form of a cone. The type of micronozzle 41 and shape of the jet 44 had little effect on the N-doped CNTs when the jet was localized in the high temperature of the heated zone 26 of the SP-CVD system 10.

As can be seen in FIG. 1 the outlet 42 of the mixer 34 is within the tube 22. The outlet 22 need not be placed within the tube 22 but may be flanged or connected directly to the tube or vessel 22. Importantly, for top performance the liquid jet 44 pulverized by the carrier gas 5 should be created within the elevated temperature zone 26 produced by the heater 25.

Example: A spraying nozzle 41 is designed to continuously pulverize solutions injected at very low feed rates of microliters per minute. The system 10 consists of an electronically controlled heater/furnace 25 with 300 mm effective heating length, a quartz reactor deposition tube/chamber 22 (i.d. 25.4 mm). The system 10 delivers a liquid spray at low flow rates and consists of an injection pump 32 connected to a copper tube 33 (i.d. 1.5 mm) for carrying the active liquid solution 7. The copper tube 33 is sealed inside a carrier gas tube solvent mixer 34 (i.d. 4.2 mm) having an outlet 42 with a capillary spraying nozzle 41 (i.d. 0.292 mm, Sigma Aldrich syringe needle gauge #24). The pressure generated inside the carrier gas tube liquid mixer 34 pulverizes, the solution 7 even at low flow rates, through the nozzle 41, into the deposition chamber 22, up to the substrate base 27 surface that is placed in the middle of the deposition chamber 22. The present deposition method is economical, controllable, and can be used continuously for depositions requiring long time intervals.

Oriented n-type (1, 0, 0) silicon (Si) wafers are used in the Example as a substrate, that included a native oxide layer, that is the Si wafer was used without removing the native oxide layer. An aluminum (Al) under-layer, with the thickness of 30 nm, was magnetron sputtered on the Si substrate.

The liquid 7 is an active solution of 0.03 g/ml concentration ferrocene (Fe(C₅H₅)₂) dissolved in acetonitrile (CH₃CN) or 0.016 mmol/ml. Ferrocene produces metallic iron particles and acts as the catalyst during the pyrolysis/synthesis process while the acetonitrile provides the carbon/nitrogen feedstock for the multi-branched N-doped CNT described herein. The liquid 7 is continuously sprayed into the deposition chamber set and controlled at a temperature of 700° C. Nitrogen is used as the carrier gas at a flow rate of 150 sccm (standard cm³). The solution is sprayed into the deposition chamber that is at a set temperature and produces a pyrolysis reaction. The reaction breaks down the carbon/nitrogen feedstock and catalyst into various active species, producing multibranched N-doped carbon nanotubes, comprising at least three stages. The reaction is maintained for 50 min. Upon completion a total of 3 ml of solution is fed at a rate of 0.06 ml/min in the CVD system 10. After the N-doped CNTs growth is completed, the reactor is allowed to cool down under nitrogen flow before exposure to air.

The N-doped CNTs samples were characterized by scanning electron microscopy (SEM—Hitachi S-4800), transmission electron microscopy (TEM—Philips CM-10) and Raman spectroscopy (Raman—Renishaw 785 nm laser excitation). The TEM samples were prepared by sonicating a small piece of as-grown nanotubes in ethanol for 10 min and drying a few drops of suspension on a Cu micro-grid. The nitrogen amount was determined by X-ray photoelectron spectroscopy (XPS—Kratos AXIS Ultra, AIKα).

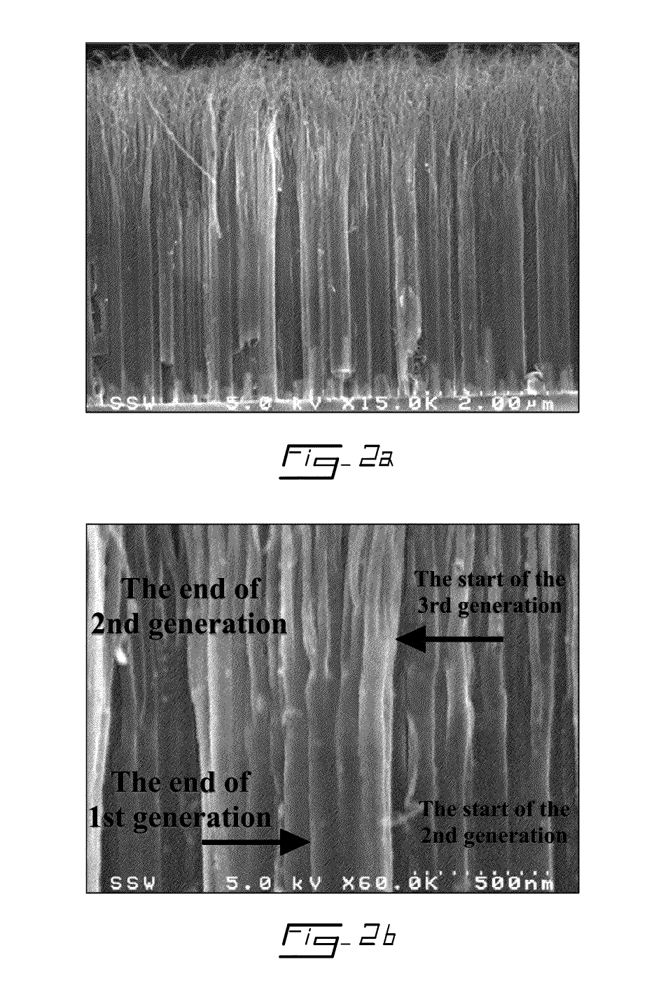

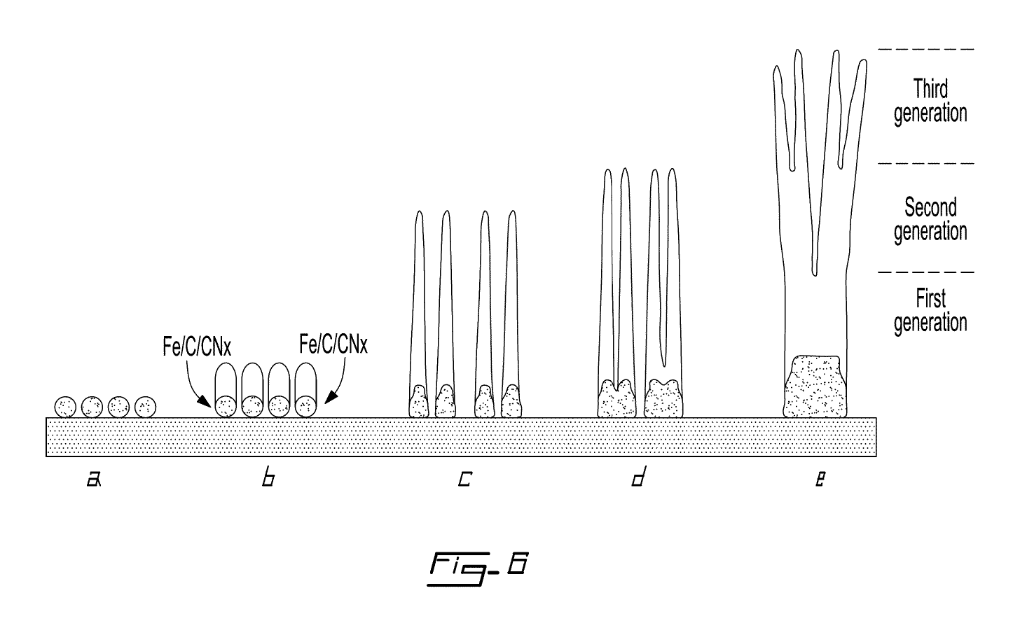

Results and discussion: The Si substrate from the deposition chamber was totally covered by a black carpet-like deposit film upon injection of the pyrolyzed nitrogen containing liquid. SEM observation of the product reveals that the film consists of vertical aligned and multi-branched carbon nanotubes with an average length of about 5 μm (FIGS. 2a and 2b). Along the length direction of the nanotubes include (from top to bottom towards the substrate): multiple thin nanotubes from a third-generation of branches converging into thicker nanotube bundles that are all (approximately) at the same height from the substrate. These nanotubes bundles form the second-generation of branches and are joined onto a stalk nanotube. The length of the first-stage stalk nanotubes is approximately 2.5 μm, the stalk is understood as the first generation or first stage of CNT adjacent the Si substrate. The outer diameter of stalk nanotubes ranges from 145 nm to 450 nm with an average of about 210 nm. The stalk nanotubes adhere to the substrate through a catalyst particle inclusion on the base, when ferrocene is used the catalyst particle inclusion are iron inclusions (as illustrated in FIG. 6). The structure composed by different generation of branches and the stalk nanotubes forms what can be defined as the hierarchical multi-branched structure.

FIG. 2a clearly illustrates a Scanning Electron Micrograph of an entire length of well-aligned branched CNTs array with different generation of branches visible produced by the process previously described. FIG. 2b in a smaller scale SEM that more clearly illustrates the location of branching from the first generation/stage to the second and then from the second generation/stage to the third generation/stage.

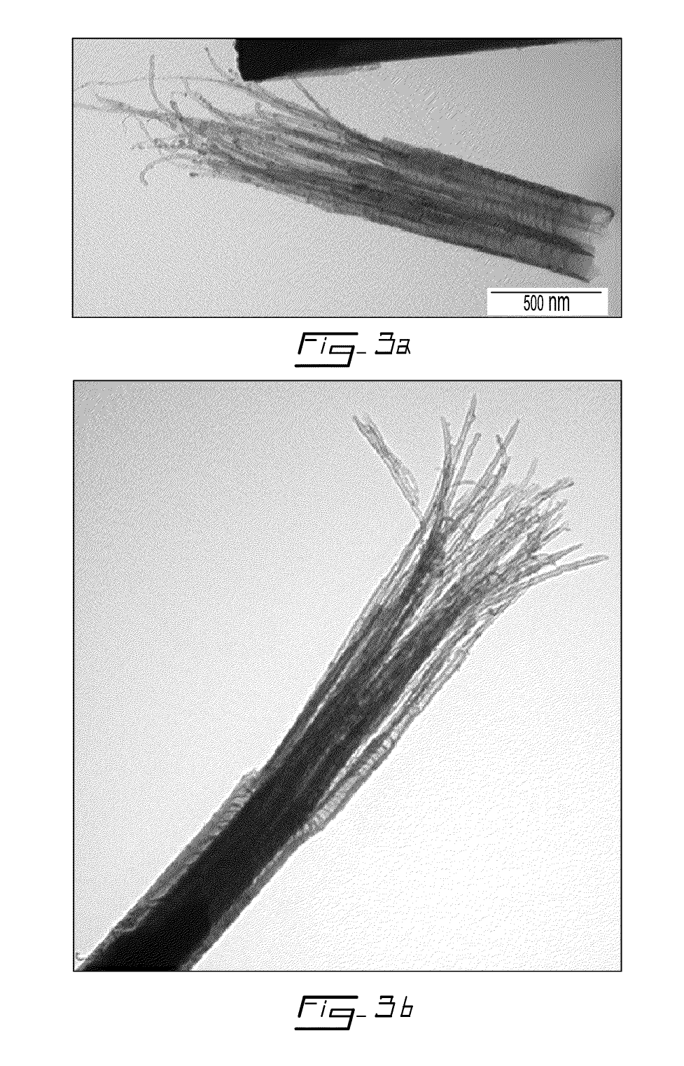

The TEM images of FIGS. 3a and 3b, provide insight into the fine structure of the branched CNTs that show two typical images of the multi-branched CNT, indicating the structure transition from the first-generation of nanotubes to the third generation of the nanotube. The nanotubes from third-generation/stage (opposite the stalk) have an average diameter of 15 nm. The average number of third-stage nanotubes grown from a single stalk nanotube may exceeds 20 branches for thick stalk nanotubes. A feature visible in the TEM micrographs is that some nanotubes from third-generation present an additional and short Y-junction at their tip (FIG. 3b). In FIGS. 3a and 3b junctions between the third and second-generation of nanotubes are visible. Most branches are formed from multi-terminal junctions where two or more branches from the second-generation converge into the first generation stalk nanotube (FIG. 3b). Branches are generally oriented in the same direction as the stalk nanotube. The diameter of the nanotubes increased due to an aggregation of branches is almost the same size as the diameter of the stalk nanotube. The third generation of nanotubes features a closed tip without any visible catalyst particle inclusion. In addition, the product contains minor amounts of amorphous carbon or catalyst particles encapsulated in the inner core or attached to the nanotube surface. The catalyst particles remain encapsulated at the root of the stalk nanotubes, likely indicating that branches are formed by the coalescence of the catalyst particles on the substrate and the branched CNTs follow a base growth mode.

Multiple branches are formed from the stalk nanotube approximately at the same height from the substrate and the diameter of the aggregation of branches is almost identical to the diameter of the stem nanotube. The branched junctions had a similar configuration in that an average of six branches with similar diameters, which were oriented in nearly the same direction, converged into a larger diameter stem. In comparison with these results, the branched structure obtained in our study present large diameter stalk nanotubes, multiple generations of branches, and a large number of first-generation of CNTs. To the best of our knowledge, it is reported for the first time that such a large number of branched CNTs can be generated from a single stalk CNT.

TEM investigation also indicates that branch nanotubes and stalk nanotube present interlinked bamboo-like structure and irregular corrugated structure. This disordered structure was further characterized by Raman spectroscopy.

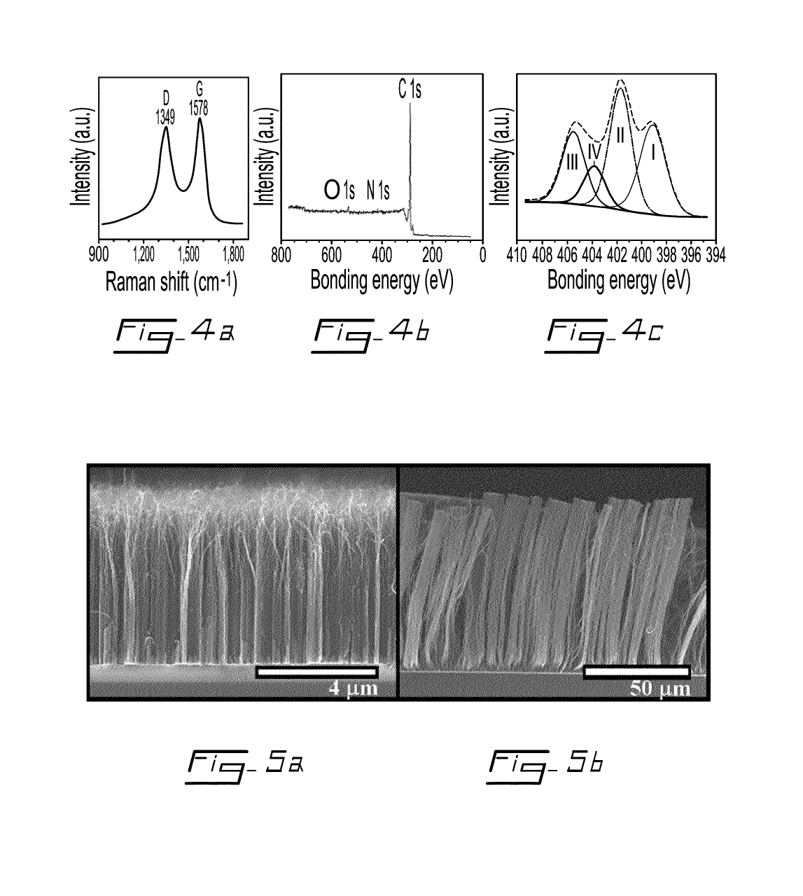

First-order Raman spectrum (FIG. 4a) indicates a strong signal around 1578 cm⁻¹, which is referred to as the G-band. The G-band corresponds to the optical phonon modes of E_{2g} symmetry in graphite and indicates the formation of well graphitized carbon nanotubes. The D-band at 1349 cm⁻¹ originates from defects that occur in the curved graphene layers and at the tube ends. The high intensity of D-band indicates that the tubes present lattice defects and disorders. Absence of radial breathing modes in the spectrum is explained by the wide range of tube diameters present in the sample, including large diameters, and demonstrates that the CNTs are multi-walled. The origin of corrugated structure and high density of defects, observed in TEM and Raman characterizations, may be associated with nitrogen incorporation in the branched CNTs during the nanotube synthesis. The nitrogen doping concentration was determined from the atomic percentage ratio of nitrogen and carbon in the XPS measurements.

FIG. 4b shows an XPS survey scan spectrum of the branched CNTs. The peaks of C 1s, N 1s and O 1s are labeled at 285, 402 and 532 eV, respectively. The oxygen signal might originate from oxygen functional groups or the residual air in the nanotubes. Nitrogen can induce different configurations of bonding environments in the nanotubes assembly. Usually four types of nitrogen are found in CNx: pyridinic, graphitic, pyrrolic and molecular nitrogen. Pyridinic nitrogen type represents a nitrogen atom located at the edge or at a defect of the graphene sheet. Graphitic nitrogen is a nitrogen atom that substitutes a carbon atom located in the graphene sheet. Pyridinic and graphitic nitrogen are both sp² hybridized. Pyrrolic nitrogen is also substitutional, but is a part of a five-membered ring and is sp³ hybridized. Molecular nitrogen can be encapsulated inside the tubes or exist as intercalated form between the graphite layers.

The N 1s XPS spectrum of the branched nanotubes is presented in FIG. 4b-d. The N1s peak can be deconvoluted into three main component peaks with binding energies of 398.9 eV (N1), 401.6 eV (N2), and 403.6 eV (N3). The low-energy N1 peak (I) at 398.9 eV corresponds to pyridine-like nitrogen. The pyridine-like sites is considered to be responsible for the wall roughness and interlinked morphologies. The peak N2 (II) at 401.6 eV is more dominant and is attributed to graphitic nitrogen. The peak N3 (III) at 403.6 eV is attributed to molecular nitrogen. Molecular nitrogen is intercalated between the nanotube layers or encapsulated in the central nanotube hollow and thus it should have no influence on the structural characteristics of nanotubes. In addition, a less intensive peak could be detected at 405.4 eV (N4) and it is assigned to the chemisorbed nitrogen oxide in the graphite layers. Pyrrolic nitrogen was not observed in the spectrum. An atomic nitrogen concentration of 2.4% was obtained by XPS measurement. Electron microscopy, Raman, and XPS characterizations indicate that the formation of the multi-stage branched carbon nanotubes depends greatly on the employed spray precursors and growth parameters.

Catalyst Concentration: During synthesis experiments of branched CNTs, it has been found that the amount of ferrocene can evidently affect the branching behavior of the nanotube growth. The optimized concentration used in previous experiments for the branched structure growth and was 3.0 wt % ferrocene in acetonitrile. No obvious changes were observed for a higher concentration of ferrocene (3.5 wt %, not shown). By decreasing the ferrocene concentration to 2.5 wt %, the total length increased to about 6 μm (FIG. 4a). The diameter of stalk nanotubes decreased to 150 nm. While the branched structure is still visible (FIG. 4b), the average number of branches obtained from a stalk nanotube decreased to 12 branches. For a further decrease of ferrocene concentration down to 0.5 wt %, the nanotubes became much longer and thinner, with a total length of 70 μm (FIG. 4c). In this case the branches almost disappeared (FIG. 4d).

Injection Rate: Injection rates over 0.1 ml/min have been reported for growing carbon nanotubes in a spray pyrolysis method. In this study, it has been found that lower injection rates favored the formation of branched CNTs. Branched nanotubes with length of 6.2 μm and stalk part of approximately 3.7 pm were obtained at an injection rate of 0.02 ml/min. The diameters of the stalk nanotube ranged from 147 nm to 450 nm. The number of the branches connected to one stalk nanotube could reach 18 branches on average. A higher injection rate of 0.06 ml/min, gave shorter branched nanotubes with the total length of 5.0 pm and a stalk length of about 2.5 μm. At this injection rate, the diameter of the stalk nanotubes and the number of nanotubes generated by a stalk remained almost unchanged based on the cross sectional view of SEM image.

When the injection rate was increased to 0.1 ml/min, an obvious change of the branch density is observed. The stalk nanotubes were shorter (1.2 μm) and the diameter decreased and ranged between 97 nm and 211 nm. Consequently, the average number of the nanotubes connected to one stalk nanotube was reduced to 9 branches. The density of the branches from a single stalk nanotube can be adjusted to by varying the liquid injection rate onto the substrate.

Temperature: The optimized temperature for growing multi-stage hierarchical carbon nanotubes was 700° C. CNTs could not be produced at a lower temperature of 650° C. By increasing the temperature to 800° C. and 850° C., the CNTs present fewer branches and more visible catalyst particle inclusions. With a further increase of the growth temperature to 900° C. the branched structure disappeared and corrugated CNTs were obtained.

Time: To study the formation process of different hierarchies of the multi-stage branched CNTs, the reaction was stopped after a growth time of 10, 20, 30, 40 and 60 min. In the reaction process, After 10 min. growth time and 0.6 ml injected, the nanotubes are thin with a length of around 100 nm, though some longer leading nanotubes are also formed. At this initial growth stage no branches are observed. By increasing the growth time to 20 min., the continuous feeding of active solution made the original catalyst particles larger and initiated their coalescence causing the formation of first-generation of branches. After 30 min. the stalks of the first-generation of CNTs elongate and start to converge into a larger stalk tube due to aggregation of the catalyst particles. With a further increase of the growth time to 40 min, the stalk nanotubes are clearly formed and sustain the first and second-generation of CNTs. By increasing the deposition time to 50 min. or 60 min., the stalk nanotubes elongate and no further branches are observed. This may be explained due to the large diameter, thick walls, and strong adhesion to the substrate of stalk nanotubes.

Growth Mechanism: Based on the above SEM and TEM observations a possible formation mechanism of branched and multi-stage CNTs is proposed (FIG. 6) including steps a) to e).
a) The decomposition of acetonitrile/ferrocene droplets by spray pyrolysis produces catalyst clusters on the substrate and an atmosphere rich in active species such as CₓH_{y}, CNₓ species, N₂, and H₂ molecules. Fe clusters adhere to the substrate, start to form nanoparticles, and react with CₓH_{y}, CNₓ species, and N₂ molecules.
b) C and CNₓ species are absorbed and precipitate on the Fe catalyst particles to form individual capped CNTs. The small and reactive metal particles give a strong interaction with precipitated species and form a graphene cap that stops the carbon source flux over the catalyst. The carbon source can be provided only at the catalyst/substrate interface along with more catalyst particles. The Fe particle density and adhesion to the substrate are large enough to sustain vertically aligned nanotubes in a base type growth.
c) During the CNT growth, elongation of the catalyst particle increases its strain energy. This results in pushing the capped nanotubes away from the substrate and in forming bamboo or corrugated structures. This leads to growth of the first-stage CNTs.
d) Injecting the precursors at low rates increases the catalyst size and, consequently, the distance between catalyst particles is gradually reduced. At this stage, multiple adjacent catalyst particles coalesce due to continuous spraying. After the Fe catalyst particles become larger, the first-stage of nanotubes is complete, multi-terminal branches are formed, and stem CNTs with larger diameters continue to grow on the substrate. This results in the production of the first-generation of branched CNTs.
e) Following a similar process, the second-generation of CNTs is formed which converge into a large diameters stalk nanotubes.

By continuing the synthesis process, the stalk nanotubes continue to grow without being able to generate further branches due to their large diameters, thick walls, and strong adhesion to the substrate. The formation mechanism of the multi-stage hierarchical CNTs can be attributed to the coalescence of the catalyst particles on the substrate during the growth process.

This N-doped CNT structure described herein provides several important characteristics, particularly: stalk nanotubes having large diameters that may be applicable to nano-energetic material enclosures; consistent height (distance) of branch formation occurs from the level of the substrate, and the CNTs includes a multiple stages and a plurality of branches. These properties are likely to be useful nanoelectronics and energy conversion devices.

The embodiments of the invention described above are intended to be exemplary. Those skilled in the art will therefore appreciate that the foregoing description is illustrative only, and that various alternate configurations and modifications can be devised without departing from the spirit of the present invention. Accordingly, the present invention is intended to embrace all such alternate configurations, modifications and variances which fall within the scope of the appended claims.

1. A multibranched N-doped carbon nanotube comprising:
a first-stage stalk having a direction and comprising
a first-stage base, and
a first-stage top opposite to and attached with the first-stage base,
wherein the first-stage base includes a catalyst inclusion,
at least two second-stage bundles, each of which comprises
a second-stage base attached with the first-stage top, and
a second-stage top opposite to and attached to the second-stage base, and
wherein the second-stage bundles branch from the first-stage stalk in substantially the direction of the first stage stalk, and
a plurality of third-stage nanotubes each of which comprises
a third-stage base attached with the second-stage top,
a third-stage top opposite to and attached to the third-stage base, and
wherein the third-stage nanotubes branch from the second-stage bundles.

2. The N-doped carbon nanotube of claim 1, wherein the first-stage stalk has an average diameter of about 145 nm to about 450 nm.

3. The N-doped carbon nanotube of claim 1, wherein the first-stage stalk has an average diameter of about 200 nm to about 250 nm.

4. The N-doped carbon nanotube of claim 1, wherein the first-stage stalk has an average diameter of about 210 nm.

5. The N-doped carbon nanotube of claim 1, wherein the second-stage bundles has an average diameter of about 25 nm to about 60 nm.

6. The N-doped carbon nanotube of claim 1, wherein the second-stage bundle has an average diameter of about 40 nm.

7. The N-doped carbon nanotube of claim 1, wherein the plurality of third-stage nanotubes each has an average diameter of about 5 nm to about 25 nm.

8. The N-doped carbon nanotube of claim 1, wherein the plurality of third-stage nanotubes each has an average diameter of about 10 nm to about 20 nm.

9. The N-doped carbon nanotube of claim 1, wherein the plurality of third-stage nanotubes is from 10 to 30, branching from the second-stage bundles.

10. The N-doped carbon nanotube of claim 1, wherein the plurality of third-stage nanotubes is from 20 to 25, branching from the second-stage bundles.

11. The N-doped carbon nanotube of claim 1, comprising a total length from the first-stage base to the third-stage top of about 4 μm to about 6 μm.

12. A process of producing vertically aligned multiple-branched nitrogen-doped carbon nanotubes, comprising the steps of:
providing a temperature controlled deposition chamber adjusted to a temperature from 675° C. and 850° C.;
providing a liquid having a carbon/nitrogen feedstock and an iron catalyst at a branching concentration,
providing a carrier gas;
providing a substrate in the chamber onto which the nanotubes are deposited;
injecting a volume of the liquid into the gas to produce a fine mist in the chamber oriented towards the substrate for a period of time between 40 and 1 hour,
wherein the liquid injected pyrolyzes the iron catalyst and the carbon/nitrogen feedstock into active species that adhere to the substrate and form the vertically aligned multiple-branched nitrogen-doped carbon nanotubes.

13. The process of claim 12, wherein the carbon/nitrogen feedstock is acetonitrile.

14. The process of claim 12, wherein the iron catalyst is ferrocene.

15. The process of claim 14, wherein the branching concentration of the ferrocene is greater than 0.5 wt % in the liquid.

16. The process of claim 14, wherein injecting the volume of the liquid into the gas is at a rate of about 0.02 ml/min to about 0.06 ml/min.

17. The process of claim 12, wherein the substrate comprises a high purity silicon wafer comprising a native oxide layer.

18. The process of claim 17, wherein the substrate includes an Al underlayer of an average thickness of about 30 nm that is applied by magnetron sputtering.

19. The process of claim 12, wherein the period of time is about 50 minutes.

20. The process of claim 12, wherein the temperature of the deposition chamber is from about 700° C. to about 800° C.
